(19) United States
(12) Patent Application Publication
(10) Pub. No.: US 2015/0167399 A1
(43) Pub. Date: Jun. 18, 2015

(54) COUPLING AND MUD MOTOR TRANSMISSION

(71) Applicant: LORD Corporation, Cary, NC (US)

(72) Inventors: James F. Kuhn, Erie, PA (US); Gerald P. Whiteford, Waterford, PA (US); Gregg Cune, Conroe, TX (US); Jonathan M. Owens, Chapel Hill, NC (US); Keith R. Ptak, Erie, PA (US)

(21) Appl. No.: 14/409,211

(22) PCT Filed: Aug. 2, 2013
(86) PCT No.: PCT/US2013/053411

§ 371 Date: Dec. 18, 2014

Related U.S. Application Data
(60) Provisional application No. 61/679,341, filed on Aug. 3, 2012.
(60) Provisional application No. 61/786,717, filed on Mar. 15, 2013.

(51) Int. Cl. E21B 17/02; F16D 3/04

(52) U.S. Cl. CPC E21B 17/02; F16D 3/04; F16D 2300/06

(57) ABSTRACT

A coupling suitable for transmitting torque applied to a first input to a second input shaft wherein the coupling accommodates angular changes between the input shafts. Additionally, the disclosure describes an improved mud motor transmission incorporating the coupling.

### CROSS REFERENCE TO RELATED APPLICATION

This application relates to and claims priority to U.S. Provisional Patent Application Ser. No. 61/786,717, filed Mar. 14, 2013, and to U.S. Provisional Patent Application Ser. No. 61/679,341, filed Aug. 3, 2012, the disclosures of which are incorporated by reference herein in their entirety.

### BACKGROUND

When drive shafts must accommodate changes in angular relationship, the transfer of energy from one shaft to another requires a coupling suitable for transferring torsional force, i.e. torque, while permitting relative movement between shafts on either side of the coupling. Universal joints and constant velocity joints are two commonly used couplings for this purpose. In the oil production industry, jaw clutches or similar devices provide this function. When used to convey both torque and axial loads, these couplings are placed under extreme loads leading to premature failure.

The present invention provides a new coupling suited for transferring torsional energy from one shaft to another. In particular, the coupling of the present invention permits transfer of torsional energy from one shaft to another while accommodating eccentric or parallel offset shaft alignments. As a result the present invention substantially eliminates or at least substantially minimizes angular changes in movement produced at either input shaft

### SUMMARY

In one embodiment, the present invention provides a coupling suitable for transferring torsional energy from one shaft to another. The coupling comprises a first input shaft having a first end and a second end. The second end has at least one recessed slot and at least one outwardly projecting ridge. Additionally, the coupling includes a second input shaft having a first end and a second end. The first end has at least one recessed slot and at least one outwardly projecting ridge. Positioned between the input shafts is a wear disk having a first wear surface and a second wear surface. The first wear surface has at least one outwardly projecting ridge and at least one recessed slot and the second wear surface has at least one outwardly projecting ridge and at least one recessed slot. The ridges of the input shafts are received within the slots of the wear disk while the ridges of the wear disk are received within the slots of the input shafts. Thus, the coupling permits lateral movement of components relative to one another.

In another embodiment, the present invention provides a mud motor transmission. The mud motor transmission comprises a coupling housing with a first input shaft rotatably positioned within the coupling housing. The first input shaft has a first end adapted for connection to a mud motor and a second end. The second end has at least one recessed slot and at least one outwardly projecting ridge. Additionally, a second input shaft is rotatably positioned within the housing. The second input shaft has a first end and a second end with the first end having at least one recessed slot and at least one outwardly projecting ridge and the second end adapted for connection to an articulated coupling. Positioned between the first input shaft and the second input shaft is a wear disk. The wear disk has a first wear surface and a second wear surface, the first wear surface having at least one outwardly projecting ridge and at least one recessed slot, the second wear surface having at least one outwardly projecting ridge and at least one recessed slot. A second housing secured to or integral with the coupling housing houses a first radial bearing, a second radial bearing, and a thrust bearing. The second input shaft passes through the first and second radial bearings and the thrust bearing. The first input shaft, the wear disk, the second input shaft, the radial bearings and the thrust bearings isolate the articulated coupling from axial forces received at the first input shaft. A bent housing, secured to the bearing housing houses an articulated joint secured to the second end of the second input shaft. The configuration of the coupling housing, the coupling, the bearing housing and the thrust bearing isolate the articulated joint from axial forces transmitted along the drill string incorporating the mud motor transmission.

### BRIEF DESCRIPTION OF THE DRAWINGS

FIG. 1 is a side view of a coupling of the current invention.

FIG. 2 is a cut-away view of a mud motor transmission supporting a bit box and a drill bit.

FIG. 3 is a side cut-away view taken along line 3-3 of FIG. 1 depicting the fluid passageway through the coupling.

FIG. 4 depicts the wear disk of the coupling positioned on an input shaft.

FIGS. 5a, 5b and 5c depict alternative embodiments of the wear disk.

FIGS. 6a, 6b and 6c depict the movement of wear disk between input shafts. With reference to FIG. 6a, FIG. 6b is rotated at a 120° degree clocking angle and FIG. 6c is rotated at a 210° degree clocking angle.

FIG. 7 depicts a cut-away view of a mud motor transmission with the coupling of FIG. 2 positioned within the housing of the mud motor transmission.

FIG. 8 depicts the fluid flow paths around and through the coupling when positioned within the mud motor transmission housing.

FIG. 9 depicts the fluid flow paths through an articulated joint secured to the lower end of an input shaft forming part of the coupling when the coupling is positioned within the mud motor transmission housing.

FIG. 10 is a side cut-away view of an articulated joint suitable for use within a mud motor transmission.

FIG. 11 is a side view of an articulated joint suitable for use within a mud motor transmission. As depicted, the articulated joint of FIG. 10 has been rotated about 90° from the position depicted in FIG. 9.

FIG. 12 is a side cut-away view of mud motor transmission utilizing the coupling of the current invention depicting the transmission of axial and torsional forces by the transmission.

FIG. 13 is an accelerometer graph depicting and comparing the measured accelerations parallel to the length of the transmission, i.e. the X-axis, for a coupling according to the current invention and a “jaw clutch” type coupling.

FIG. 14 is an accelerometer graph depicting and comparing the measured accelerations perpendicular to the length of the transmission and in the vertical axis, i.e. the Y-axis, for a coupling according to the current invention and a “jaw clutch” type coupling.

FIG. 15 is an accelerometer graph depicting and comparing the measured accelerations perpendicular to the length of the transmission and in the lateral axis, i.e. the Z-axis, for a coupling according to the current invention and a “jaw clutch” type coupling.

FIG. 16 represents a testing configuration suitable for determining g-force experienced by the coupling of FIG. 1.

### DETAILED DESCRIPTION

The present invention provides an improved coupling 10 designed for transmission of torsional and axial forces. The configuration and operational aspects of coupling 10 will be described in terms of a mud motor transmission. However, coupling 10 is suitable for use in devices requiring transmission of torque through a coupling requiring accommodation of angular changes between drive shafts. Non-limiting examples of such operations may include drive shafts wherein coupling 10 replaces universal joints or continuous velocity joints.

With initial reference to FIGS. 1, 3-6, coupling 10 includes a first input shaft 12, a wear disk 14 and a second input shaft 16. First input shaft 12 has a first end 18 and a second end 20. Second input shaft 16 has a first end 22 and a second end 24. Wear disk 14 has a first wear surface 26 and a second wear surface 28. First end 18 of first input shaft 12 and second end 24 of second input shaft 16 may be threaded or configured in any convenient manner for securing to other components in a drive train or a drill string.

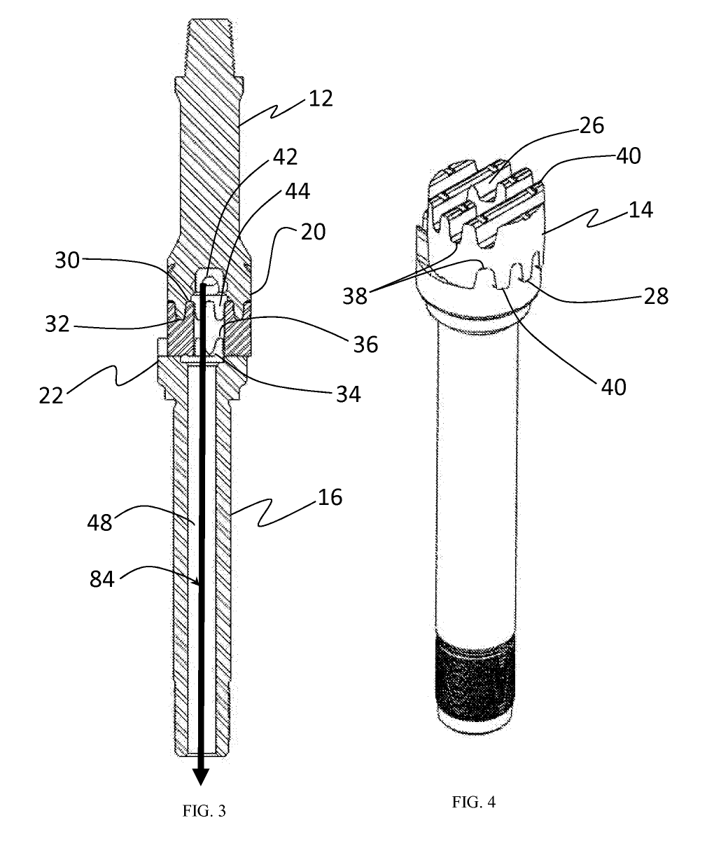

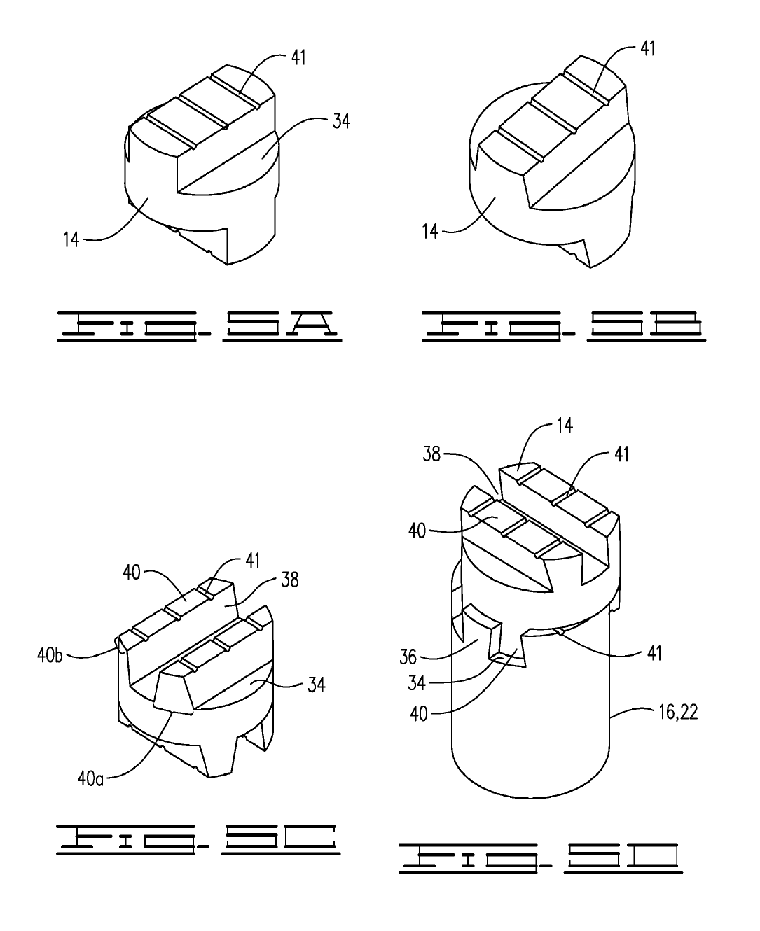

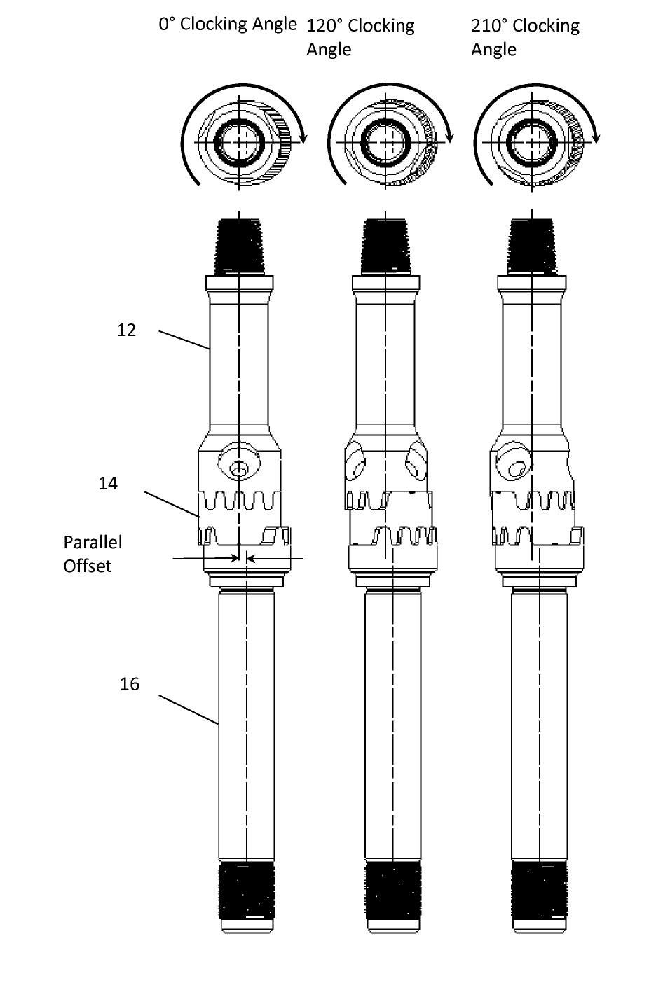

As depicted more clearly in FIGS. 3 and 4, second end 20 of first input shaft 12 has at least one slot 30 and at least one outwardly projecting ridge 32. Similarly, first end 22 of second input shaft 16 has at least one slot 34 and at least one outwardly projecting ridge 36. Each wear surface 26 and 28 of wear disk 14 has a corresponding slot 38 and a corresponding ridge 40 configured to receive or mate with slots 30, 34 and ridges 32, 36 of input shafts 12, 16. As depicted in FIGS. 5a-5d, slots 34 on wear disk 14 may have only one defining wall. The same applies to input shafts 12, 16.

The geometric configuration of slots 30, 34, 38 and ridges 32, 36, 40 may vary with the use of coupling 10. Suitable configurations include, but are not limited to, rectangular, trapezoidal (i.e. tapered), triangular and scalloped. Ridges and slots will generally have corners rounded to reduce friction and stress. Generally, ridges 32, 36, 40 will have a trapezoidal or tapered configuration as depicted in FIGS. 5b and 5c. Typically, a tapered or trapezoidal surface will allow for coupling wear without loss of face contact. Thus, this configuration extends coupling life by maintaining the relative alignment and configuration of coupling components. The height, width, taper angle and number of teeth can be varied for the coupling size and application. The change in width for ridges 32, 36, 40 from the base 40a of ridge 40 to the terminal surface 40b may be between 0% and 50%. Typically, for trapezoidal ridges 40, terminal surface 40b will be between 10% and 50% narrower than base 40a. FIG. 5d depicts an optional configuration. As depicted therein, coupling 10 utilizes reversed taper or a “dovetail” configuration for slots 30, 34, 38 and ridges 32, 36, 40. The configuration of FIG. 5d precludes separation of coupling 10 due to tension or pulling forces.

Further, as depicted in FIGS. 4-5d, outwardly projecting ridges 40 carried by wear disk 14 optionally include lubrication grooves 41 in terminal surface 40b. Although shown only on ridges 40 of wear disk 14, all contact surfaces of coupling 10 may include lubrication grooves to enhance movement of drilling mud and other lubricants across and through coupling 10.

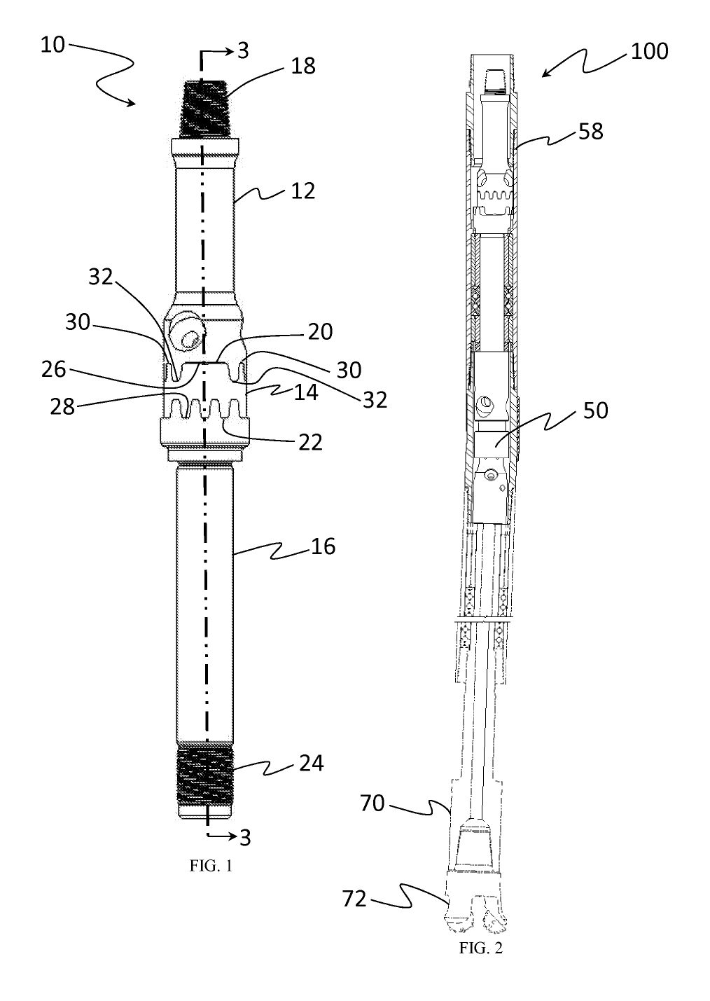

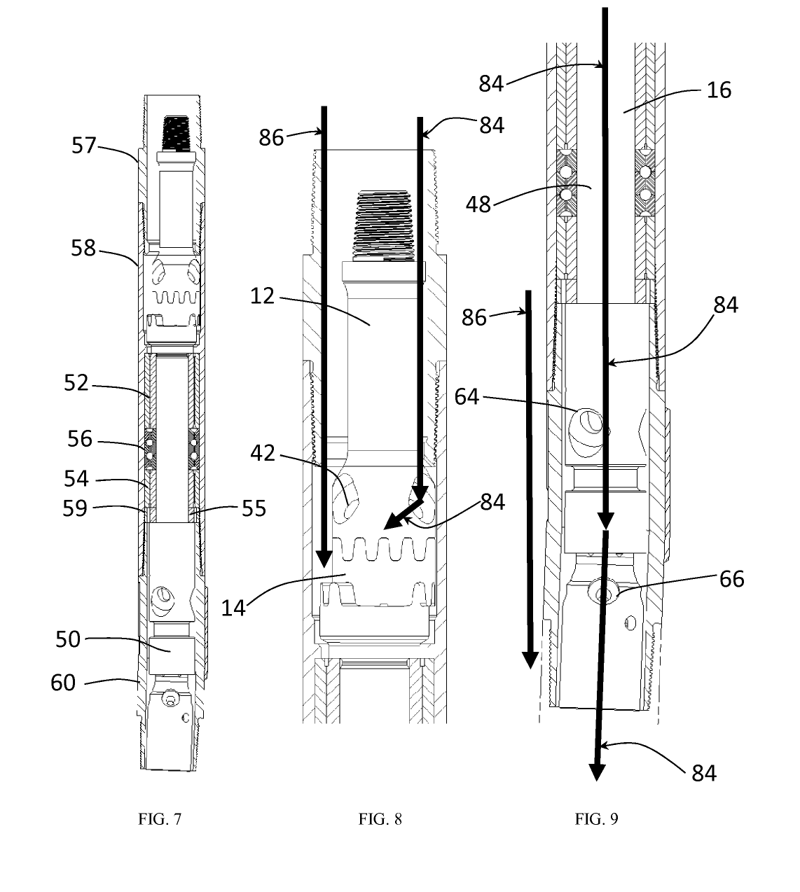

Wear disk 14 transfers torsional and axial forces received at first input shaft 12 to second input shaft 16 while accommodating eccentric or parallel offset shaft alignments thereby substantially eliminating or at least substantially minimizing angular changes in movement produced at either input shaft 12, 16. See FIGS. 6a-c. The configuration and cooperation of slots 30, 34, 38 and ridges 32, 36, 40 permit lateral slippage between input shafts 12, 16 and wear disk 14. Such movement between components will naturally produce surface wear. As depicted in the FIGS., when using wear disk 14 of FIGS. 5a-5c, input shafts 12, 16 are not physically secured to wear disk 14. Thus the configuration of wear disk 14 in cooperation with input shafts 12, 16 provides continuous structural alignment of coupling components, despite erosion of surfaces on wear disk 14 and input shafts 12, 16. Further alignment relationship is provided by a coupling housing 57 as depicted in FIGS. 2, 7 and 8.

As depicted, coupling housing 57 defines the lateral limitations of input shafts 12, 16 and wear disk 14. During operation, the configuration of slots 30, 34, 38 and ridges 32, 36, 40 provides a consistent axial configuration of input shafts 12, 16 to one another despite erosion of wear surfaces 26 and 28 of wear disk 14. To provide for a generally even rate of erosion across surfaces 26 and 28, wear disk 14 will generally be manufactured from a high-strength alloy steel, such as 300M, 4340, 8620 or a stainless steel composition identical to that used for the shafts 12 and 16 with all contact surfaces carrying optional hard coatings such as a ceramic based or cobalt-tungsten carbide coating to provide additional wear and abrasion resistance. Alternatively, wear disk 14 may be made from a sacrificial material such as a high strength bronze. In one embodiment, all sliding or contact surfaces 26, 28, and ends 20, 22 will carry a wear and abrasion resistant surface treatment. As will be explained in more detail below, in the context of a mud motor transmission, the unique, unsecured, arrangement of wear disk 14 between input shafts 12, 16 provides for the efficient translation of rotational energy between non-aligned input shafts, i.e. input shafts having offset, parallel axes of rotations. In general, the configuration of input shafts 12, 16 and wear disk 14 reduces g-force values experienced by coupling 10 by about 80% to about 93% when compared to a conventional “jaw clutch” coupling currently used by the industry thereby reducing shock to internal components, providing quieter operations and lengthening the operational life of coupling 10.

As depicted in FIG. 2, when used within mud motor transmission 100, coupling 10 will carry an articulated joint 50 secured to end 24 of second input shaft 16. Typically, articulated joint will be threaded onto input shaft 16. Positioned between articulated joint 50 and coupling 10 are first and second radial bearings 52, 54 and a thrust bearing 56 with second input shaft 16 passing through the bearings. Inner spacer 55 and outer spacer 59 permit adjustment of preload on thrust bearing 56. Although not previously used in this portion of a mud motor transmission, those skilled in the art are familiar with the techniques and settings necessary for proper adjustment and operation of thrust bearing 56 by adjusting preload through inner spacer 55 and outer spacer 59. The bearings are maintained in place by a bearing housing 58 secured to coupling housing 57. Optionally, bearing housing 58 and coupling housing 57 may be a single integral unit with the identified components position within the single housing. Finally, a bent housing 60, also known at a bend housing, houses articulated joint 50. Bent housing 60 is secured by conventional means to bearing housing 58. Finally, articulated joint 50 may be secured to any conventional bit box 70 carrying bit 72 or secured to other driven downhole tools known to those skilled in the art.

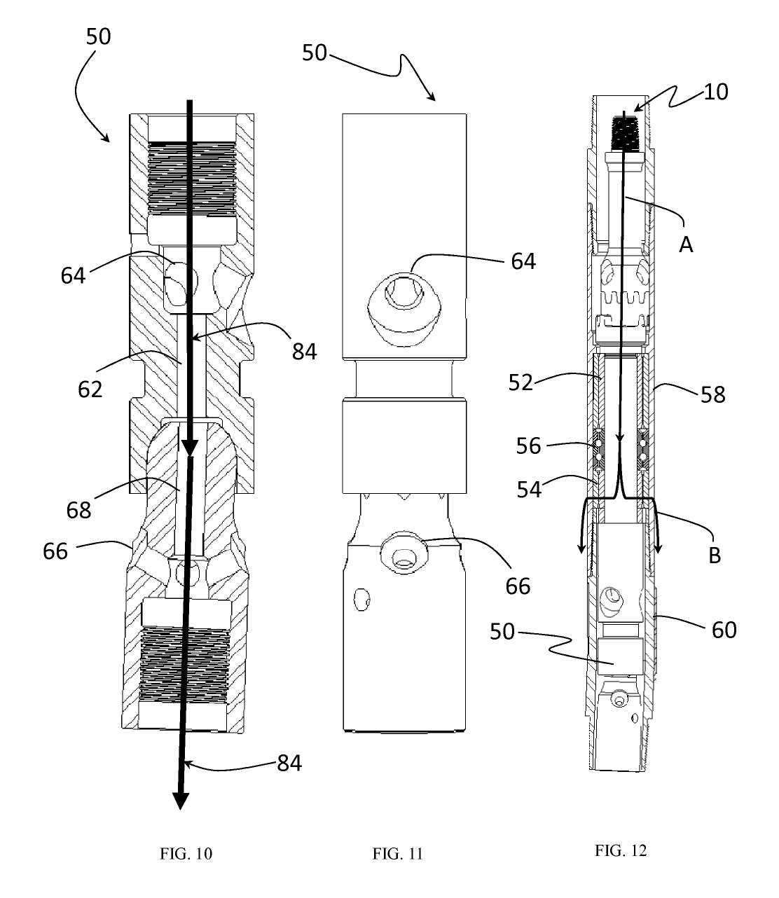

Further, as depicted in FIG. 8-10, coupling 10 includes at least one fluid port 42 suitable for conveying drilling mud from the exterior of coupling 10 to a fluid passage 44 within input shaft 12. Fluid passage 44 provides fluid communication with passage 46 in wear disk 14 and passage 48 within second input shaft 16. As such, port 42 and passage 44 provide fluid communication for a lubricating fluid to interior portions of slots 30, 34, 38 and ridges 32, 36, 40. When used in a mud motor transmission, the drilling mud will provide the necessary lubrication to radial bearings 52, 54 and thrust bearing 56. When used in other torque transfer settings, fluid port 42 and passage 44 will provide fluid communication from the exterior to the interior for any convenient lubricating fluid.

Thus, as depicted in FIGS. 8-10 coupling 10 provides for fluid communication between a mud motor (not shown) positioned above and secured directly or indirectly to first end 18 of input shaft 12 of mud motor transmission 100. Fluid received from the mud motor passes through input shafts 12, 16 and wear disk 14 to articulated joint 50. To provide for fluid communication between mud motor transmission 100 and a bit 72, articulated joint 50 includes a first central passage 62, optional ports 64, 66 and a second central passage 68. Thus, mud motor transmission 100 provides for the transfer of torsional and axial forces from a mud motor to drill bit 72 while also supplying lubricating drilling mud to bit 72.

FIGS. 8 and 9 also show fluid flow paths 84, 86 for lubricating mud pass through transmission 100. Flow path 84 begins within coupling housing 58, passes through port 42 to the interior of coupling 10 thereby providing lubrication to the interior surfaces of wear disk 14 and input shaft ends 20 and 22. Flow path 84 continues through the interior of second input shaft 16 and enters interior passages 62, 64 of articulated joint 50 thereby providing lubrication to articulated joint 50 and components downstream of articulated joint 50 such as bit box 70 and drill bit 72. Fluid flow path 86 also passes through coupling housing 58. That portion of drilling mud that does not pass through port 42 continues along path 86 around the exterior of coupling 10 to provide lubrication to the first radial bearing 52, second radial bearing 54 and thrust bearing 56. Mud passing along path 86 continues until reaching articulated joint 50. Within bent housing 60, optional ports 64 and 66 provide for pressure balance between paths 84 and 86 depending on internal fluid pressures and operating conditions. Thus, the configuration provides continuous fluid communication between the mud motor (not shown) and bit box 70 and bit 72 via paths 84 and 86.

Thus, coupling 10 when incorporated into mud motor transmission 100 provides the capability to drive a drill bit during directional drilling operations while providing a readily replaceable coupling. However, the present invention provides significant additional advantages.

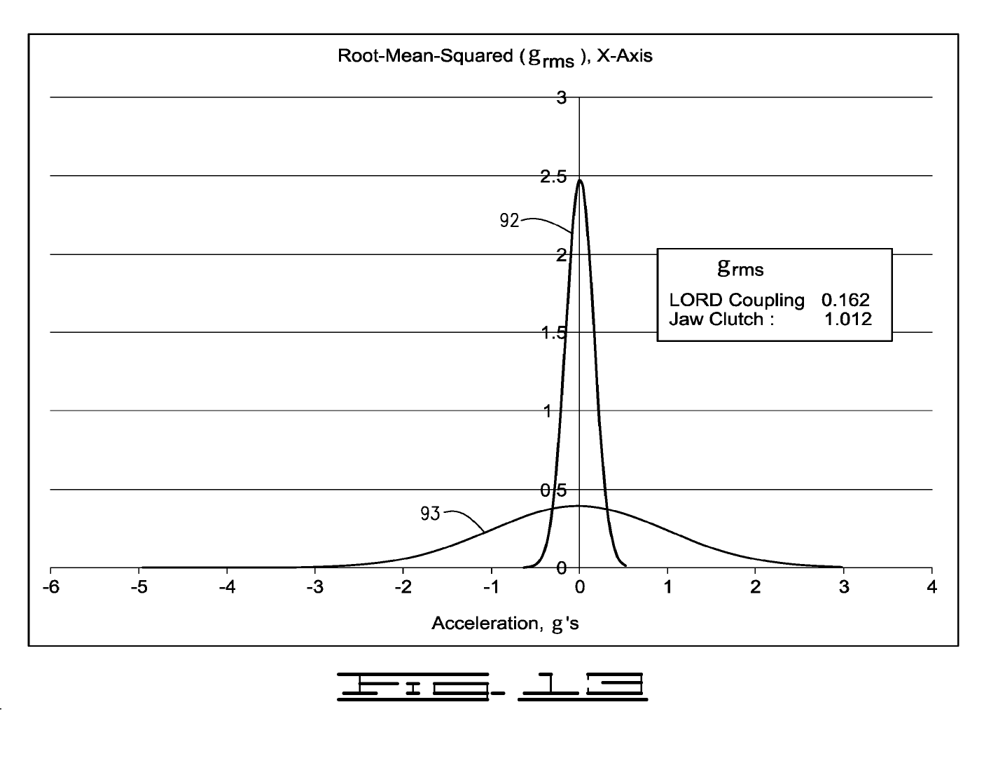

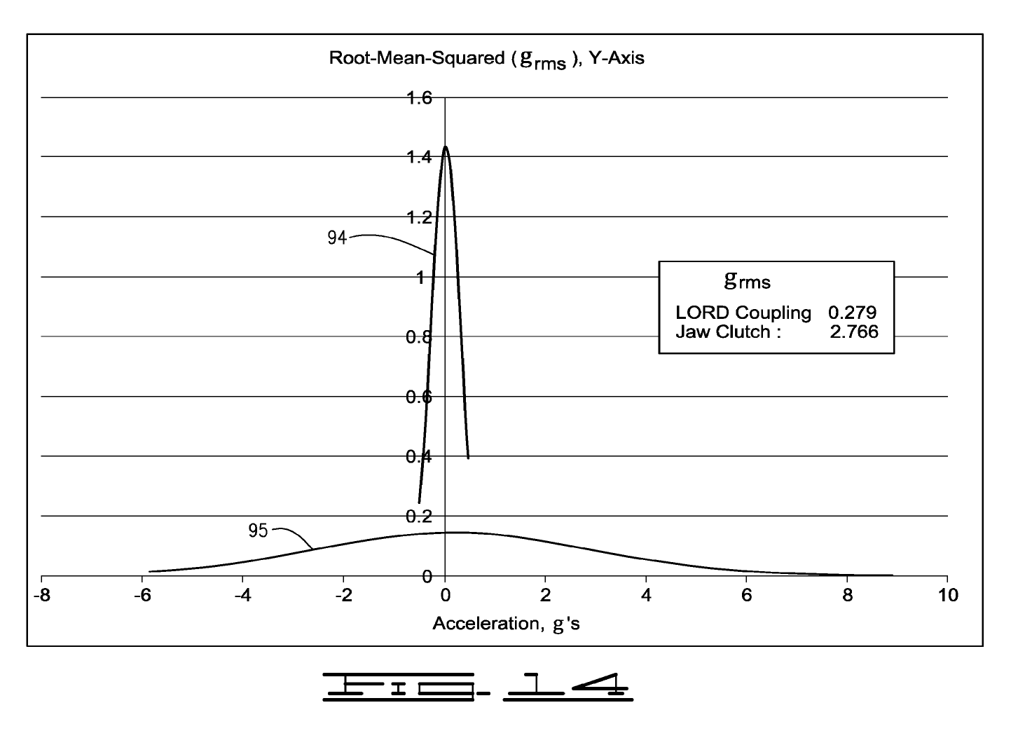

With reference to FIGS. 2 and 12, the transfer of torsional and axial force through mud motor transmission 100 will be described. In a conventional mud motor/mud motor transmission configuration all axial and rotational forces transfer from the mud motor through all components of the transmission to a bit. However, in the current invention, incorporation of coupling 10 into mud motor transmission 100 isolates articulated joint 50 from axial stresses, thereby allowing articulated joint 50 to transfer only torsional, i.e. rotational force to drill bit 72. Thus, articulated joint 50 does not carry an axial load. Rather, coupling 10, thrust bearing 56, bearing housing 58 and bent housing 60 transmit axial load, i.e. weight on bit, to bit box 70 and bit 72.

Thus, in mud motor transmission 100 of the present invention, axial forces generated by the drill string to place necessary weight on drill bit 72 do not pass through articulated joint 50. Rather, as indicated in by lines A and B in FIG. 12, axial force passes from coupling 10 through radial bearings 52, 54 and thrust bearing 56 to housing 58 and bent housing 60 to bit box 70 carrying drill bit 72. Accordingly, all axial force or weight to drill bit 72 necessary for drilling purposes passes around articulated joint 50. As such, articulated joint 50 transfers only the rotational energy, i.e. torque, imparted by mud motor to coupling 10 to drill bit 72. By isolating articulated joint 50 from axial stress, the present invention significantly extends the operational life of articulated joint 50. Conversely, the configuration of mud motor transmission 100 isolates articulated joint 50 from dynamic forces produced by drilling operations as these forces are conveyed through the same axial transmitting components.

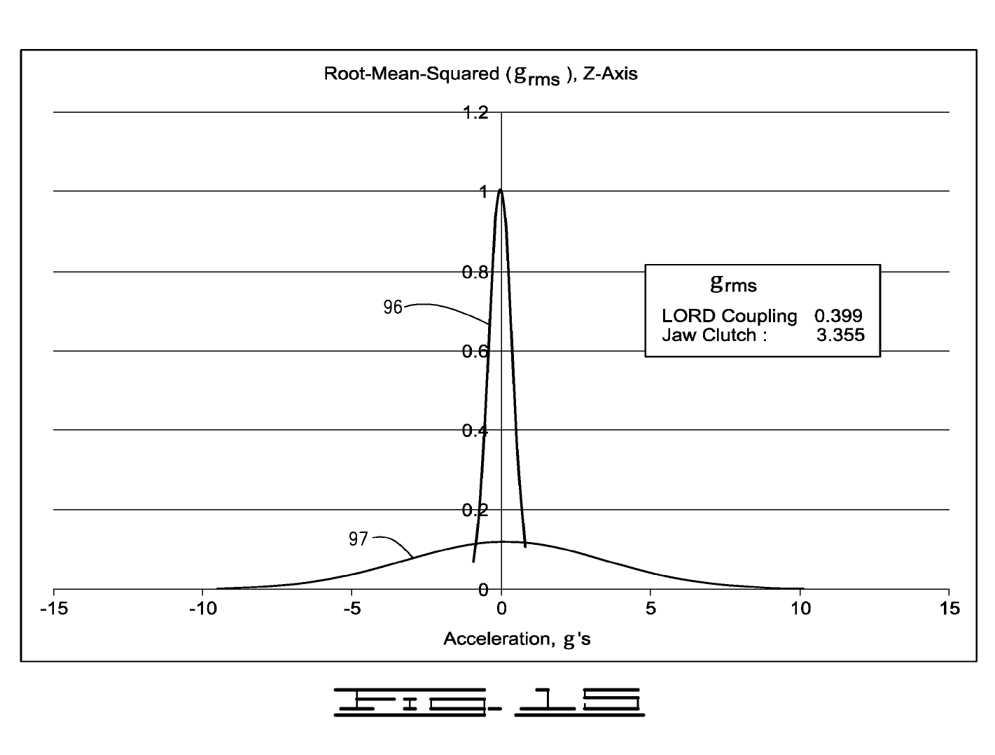

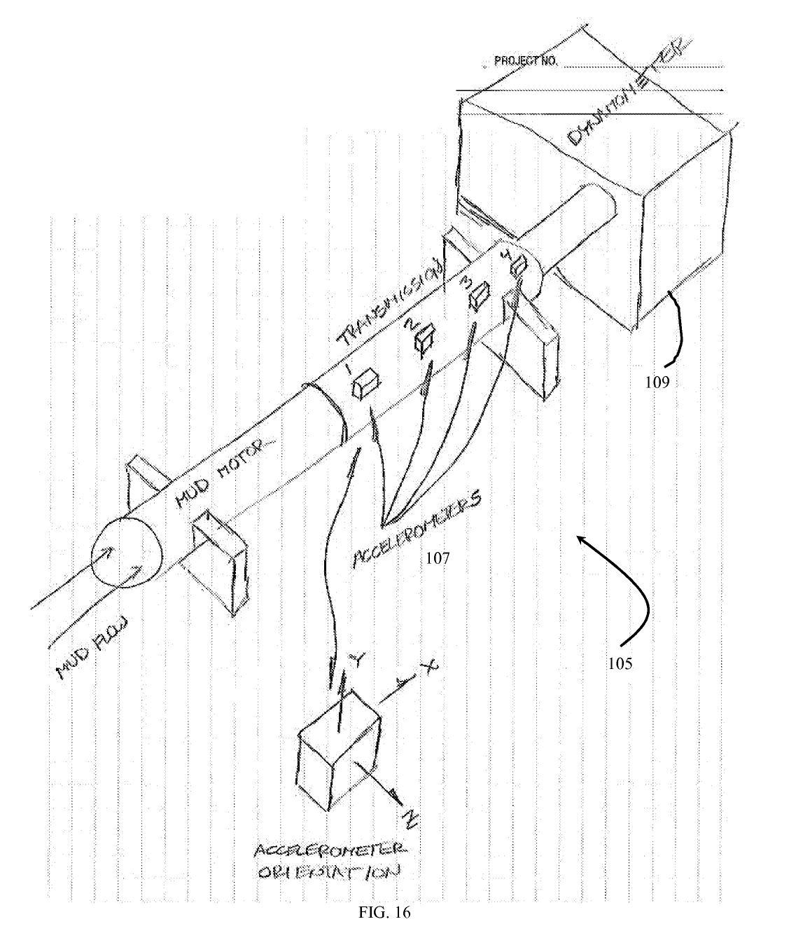

Further, with reference to FIGS. 13-15, mud motor transmission 100 provides significant operational efficiencies over previously available transmissions. To determine the vibration levels produced by coupling 10, i.e. movement inconsistent with smooth rotational transfer of energy, during operation of coupling 10 accelerometer tests were carried out using two mud motor transmissions. The accelerometer mean and standard deviation data produced by the test was used in the following normal distribution equation to generate the curves of FIGS. 13-15.

$$f ( x ) = \frac{1}{\hat{σ} \sqrt{2 π}} exp [ - \frac{1}{2} {( \frac{x - μ}{\hat{σ}} )}^{2} ]$$

$$Where σ = standard deviation$$

$$Where μ = mean$$

One transmission utilized coupling 10 and the other transmission utilized a conventional “jaw clutch” configuration. The accelerometer testing utilized a dynamometer in place of the bit box and a series of accelerometers 107 to measure g-forces in the X, Y and Z axes. A reduction in g-force measured by the accelerometers 107 reflects improved rotational energy transfer. In the case of coupling 10, without being limited by theory, we believe that the sliding movement provided by the relationship of wear disk 14 and input shafts 12, 16 eliminates or at least substantially reduces wobble or offset movement between input shafts 12, 16. Additionally, coupling 10 eliminates or substantially reduces impact stress between input shafts 12, 16. In contrast, prior art configurations such as the “jaw clutch” impart wobble and impact stress between associated input shafts.

With reference to FIG. 13, line 92 represent measured accelerations parallel to the length of the transmission (X-axis accelerometers 107) for coupling 10 and line 93 provides the same data for a “jaw clutch” type coupling. As reflected by line 92, g-forces were experienced over a range of only 1.15 g's. In contrast, the “jaw clutch” experienced g-forces over a range of 7.93 g's. Using root-mean-squared (gᵣₘₛ) values for the acceleration data, coupling 10 of the present invention has a value of 0.162 while the jaw clutch has a value of 1.012. Accordingly, the value in the X-axis for coupling 10 is 84% lower than the jaw clutch.

FIG. 14 provides the acceleration curves for accelerations measured perpendicular to the length of the transmission and in the vertical axis, i.e. the Y-axis. Line 94 provides the accelerometer values for coupling 10 and line 95 provides the values for the jaw clutch. As
reflected by line 94, g-forces coupling 10 experienced g-forces over a range of only 0.97 g's. In contrast, as reflected by line 95, the “jaw clutch” experienced g-forces over a range of 14.74 g's. Using root-mean-squared (gᵣₘₛ) values for the acceleration data, coupling 10 of the present invention has a value of 0.279 while the jaw clutch has a value of 2.766. Accordingly, the value in the Y-axis for coupling 10 is 90% lower than the jaw clutch.

FIG. 15 provides the acceleration curves for accelerations measured perpendicular to the length of the transmission and in the lateral axis, i.e. the Z-axis. Values for coupling 10 are represented by line 96 and for the jaw clutch by line 97. As reflected by line 96, g-forces coupling 10 experienced g-forces over a range of only 1.75 g's. In contrast, as reflected by line 97, the “jaw clutch” experienced g-forces over a range of 19.62 g's. Using root-mean-squared (gᵣₘₛ) values for the acceleration data, coupling 10 of the present invention has a value of 0.399 while the jaw clutch has a value of 3.355. Accordingly, the value in the Z-Axis for coupling 10 is 88% lower than the jaw clutch.

In view of the accelerometer data, one skilled in the art will recognize that coupling 10 experiences significantly less vibration induced stress than the jaw clutch during operation. The sliding relationships of the components in coupling 10 maintain the relative alignment of input shafts 12, 16. The resulting low vibrational characteristics should remain constant over the life of coupling 10. In contrast, wear within a jaw clutch may increase the vibration levels experienced by conventional couplings and subsequently transmitting the increased vibrations to downhole equipment.

Other embodiments of the present invention will be apparent to one skilled in the art. As such, the foregoing description merely enables and describes the general uses and methods of the present invention. Accordingly, the following claims define the true scope of the present invention.

What is claimed is:

1. A coupling comprising:
a first input shaft having a first end and a second end, said second end having at least one recessed slot and at least one outwardly projecting ridge;
a second input shaft having a first end and a second end, said first end having at least one recessed slot and at least one outwardly projecting ridge;
a wear disk having a first wear surface and a second wear surface, said first wear surface having at least one outwardly projecting ridge and at least one recessed slot, said second wear surface having at least one outwardly projecting ridge and at least one recessed slot;
said wear disk positioned between said second end of said first input shaft and said first end of said second input shaft such that ridges carried by said input shafts are received within said slots of said wear disk.

2. The coupling of claim 1, wherein erosion of said wear disk does not alter the alignment of said first input shaft and said second input shaft.

3. The coupling of claim 1, wherein said wear disk is manufactured from a compound selected from the group consisting of a high strength allow steel selected from the group identified as 300M, 4340 and 8620 alloy steels, and a bronze alloy.

4. The coupling of claim 1, wherein the outwardly projecting ridges carried by said second end of said first input shaft, said first end of said second input shaft and said wear disk have a generally geometric configuration selected from the group consisting of: rectangular, trapezoidal, triangular and scalloped.

5. The coupling of claim 1, wherein the outwardly projecting ridges carried by said second end of said first input shaft, said first end of said second input shaft and said wear disk have a taper wherein the upper terminal end of said ridge is 0 to about 50% narrower than the base of said ridge.

6. The coupling of claim 1, further comprising: a central passage passing through said first input shaft, a central passage passing through said second input shaft and a central passage passing through said wear disk, thereby providing fluid communication through said coupling.

7. The coupling of claim 1, further comprising a lubrication groove on said first wear surface of said wear disk.

8. The coupling of claim 1, further comprising a lubrication groove on said second wear surface of said wear disk.

9. The coupling of claim 6, further comprising at least two lubrication grooves on said first wear surface of said wear disk, at least one lubrication groove passing from an outer edge of said disk and terminating at said central passage of said wear disk.

10. The coupling of claim 6, further comprising at least two lubrication grooves on said second wear surface of said wear disk, at least one lubrication groove passing from an outer edge of said disk and terminating at said central passage of said wear disk.

11. The coupling of claim 1, further comprising at least one lubrication groove bisecting each outwardly projecting flange of said wear disk.

12. The coupling of claim 1, further comprising a housing with said coupling rotatably positioned within said housing.

13. The coupling of claim 12, further comprising:
a first radial bearing housing positioned within said housing;
a first radial bearing positioned within said first radial bearing housing;
a second radial bearing housing positioned within said housing;
a second radial bearing positioned within said second radial bearing housing;
a thrust bearing positioned between said first and second radial bearing housings;
wherein said second input shaft passes through said first and second radial bearings and said thrust bearing;
an articulating joint rotatably positioned within said housing adjacent said second radial bearing housing, said articulating joint secured to said second end of said second input shaft.

14. The coupling of claim 13, wherein the configuration of said coupling isolates said articulating joint from axial forces received at said first input shaft.

15. The coupling of claim 13, wherein the configuration of said coupling transmits only rotational force to said articulating coupling.

16. A mud motor transmission comprising:
a housing;
a first input shaft rotatably positioned within said housing, said first input shaft having a first end adapted for connection to a mud motor and a second end, said second end having at least one recessed slot and at least one outwardly projecting ridge;
a second input shaft rotatably positioned within said housing, said second input shaft having a first end and a second end, said first end having at least one recessed slot and at least one outwardly projecting ridge and said second end adapted for connection to an articulated joint;
a wear disk positioned between said first input shaft and said second input shaft, said wear disk having a first wear surface and a second wear surface, said first wear surface having at least one outwardly projecting ridge and at least one recessed slot, said second wear surface having at least one outwardly projecting ridge and at least one recessed slot;
a first radial bearing housing positioned within said housing;
a first radial bearing positioned within said first radial bearing housing;
a second radial bearing housing positioned within said housing;
a second radial bearing positioned within said second radial bearing housing;
a thrust bearing positioned between said first and second radial bearing housings;
wherein said second input shaft passes through said first and second radial bearings and said thrust bearing; and,
wherein said first input shaft, said wear disk, said second input shaft, said radial bearings and said thrust bearings isolate said articulated coupling from axial forces received at said first input shaft.

17. The mud motor transmission of claim 16, wherein the composition of said wear disk is selected to provide for even cross-sectional wear of said wear disk thereby maintaining the axial relationship of said first input shaft and said second input shaft.

18. The mud motor transmission of claim 16, further comprising at least one lubrication groove bisecting each outwardly projecting flange of said wear disk.

19. The mud motor transmission of claim 16, wherein the outwardly projecting ridges carried by said second end of said first input shaft, said first end of said second input shaft and said wear disk have a generally geometric configuration selected from the group consisting of: rectangular, trapezoidal, triangular and scalloped.

20. The mud motor transmission of claim 16, wherein the outwardly projecting ridges carried by said second end of said first input shaft, said first end of said second input shaft and said wear disk have a taper wherein the upper terminal end of said ridge is between 0% and about 50% narrower than the base of said ridge.
